(19) United States
(12) Patent Application Publication
(10) Pub. No.: US 2013/0063778 A1
(43) Pub. Date: Mar. 14, 2013

(54) IMAGE PROCESSING SYSTEM AND IMAGE PROCESSING METHOD

(71) Applicant: Yuichi NAGASAWA, Kanagawa (JP)

(72) Inventor: Yuichi NAGASAWA, Kanagawa (JP)

(21) Appl. No.: 13/608,394

(22) Filed: Sep. 10, 2012

(30) Foreign Application Priority Data
Sep. 13, 2011 (JP) 2011-199806
Aug. 28, 2012 (JP) 2012-187892

(51) Int. Cl. G06F 3/12

(52) U.S. Cl. 358/1.15

(57) ABSTRACT

An image processing system includes an image processing apparatus; an information processing apparatus configured to transmit an instruction on image processing to the image processing apparatus; a power supply apparatus configured to supply power to the image processing apparatus. The information processing apparatus includes a first transmitting unit configured to transmit, to the power supply apparatus, start instruction to start power supply to the image processing apparatus when an execution instruction is received, and a second transmitting unit configured to transmit, to the image processing apparatus, the execution instruction and execution information needed to perform a process when a communication with the image processing apparatus is enabled. The power supply apparatus includes a power control unit configured to start power supply to the image processing apparatus when the start instruction is received.

### CROSS-REFERENCE TO RELATED APPLICATIONS

The present application claims priority to and incorporates by reference the entire contents of Japanese Patent Application No. 2011-199806 filed in Japan on Sep. 13, 2011 and Japanese Patent Application No. 2012-187892 filed in Japan on Aug. 28, 2012.

### BACKGROUND OF THE INVENTION

1. Field of the Invention

The present invention relates to an image processing system and an image processing method.

2. Description of the Related Art

Conventionally, there is a known system in which a power supply apparatus, such as a power strip, and a host apparatus manage a plurality of devices. In such a system, for example, the power supply apparatus supplies power to each of the devices, measures the power consumption of each of the devices, and transmits measurement results to the host apparatus via the network, and the host apparatus manages the measurement results. The power supply apparatus also controls on and off of the power supply to each of the devices in accordance with an instruction from the host device.

Meanwhile, there is a known image processing apparatus that enters a standby state, in which power supply to a part of the image processing apparatus is turned off, when image processing is not performed. This image processing apparatus can reduce the power consumption. There is also a known image processing apparatus that is connected to an information processing apparatus, such as a user terminal, via a network and that operates in accordance with an input from a user via the information processing apparatus. In such an image processing apparatus, the network is enabled even in the standby state so that an instruction, such as a print job, can be received from the information processing apparatus.

As a technology for reducing the power consumption of the image processing apparatus, Japanese Patent Application Laid-open No. 2002-247249 discloses a system, in which a copier and a management apparatus are connected to each other via a network and the management apparatus turns off the power to the copier when the copier is not used.

Furthermore, there is a technology for managing power supply to a plurality of devices by power over Ethernet (POE (registered trademark)). For example, Japanese Patent Application Laid-open No. 2009-081723 discloses a system in which an information processing apparatus transmits a print job to an image processing apparatus and the image processing apparatus prints an image based on the print job. In the system, to reduce the power consumption, the power to a network section is turned off when the image processing apparatus is in the standby state, and the power to the network section is turned on by PoE via a HUB or the like when the information processing apparatus transmits a print job.

However, in the image processing apparatus connected to the information processing apparatus via a network, it is necessary to maintain the enabled network even in the standby state in order to receive a print job via the information processing apparatus as described above. Therefore, it is impossible to completely turn off the image processing apparatus. Consequently, the power is consumed even in the standby state. This disadvantage may be eliminated by using PoE described above. However, installation of PoE extremely increases costs.

Furthermore, although Japanese Patent Application Laid-open No. 2002-247249 discloses a structure for turning off the power of the copier, it is impossible to turn on the copier and a user cannot perform printing at a desired timing in the structure disclosed in Japanese Patent Application Laid-open No. 2002-247249.

Therefore, there is a need to provide an image processing system and an image processing method capable of, without an increase in costs, turning on the power to the image processing apparatus at an appropriate timing from the standby state in which the power is turned off.

### SUMMARY OF THE INVENTION

It is an object of the present invention to at least partially solve the problems in the conventional technology.

According to an embodiment, there is provided an image processing system that includes a first image processing apparatus; an information processing apparatus configured to transmit an instruction on image processing to the first image processing apparatus, the information processing apparatus being connected to the first image processing apparatus via a network; and a power supply apparatus configured to supply power to the first image processing apparatus, the power supply apparatus being connected to the information processing apparatus via the network. The information processing apparatus includes an execution instruction receiving unit configured to receive an execution instruction on a predetermined process to be performed by the first image processing apparatus; a first transmitting unit configured to transmit, to the power supply apparatus, a first start instruction to start power supply to the first image processing apparatus when the execution instruction is received; a first communication monitoring unit configured to monitor whether a communication with the first image processing apparatus is enabled; and a second transmitting unit configured to transmit, to the first image processing apparatus, the execution instruction and execution information needed to perform the predetermined process when the communication with the first image processing apparatus is enabled. The power supply apparatus includes a first receiving unit configured to receive the first start instruction from the information processing apparatus; and a power control unit configured to start power supply to the first image processing apparatus when the first start instruction is received. The first image processing apparatus includes a first power supply unit configured to start power supply to components of the first image processing apparatus when power is supplied by the power supply apparatus; a second receiving unit configured to receive the execution instruction and the execution information from the information processing apparatus when the first power supply unit starts power supply to the components of the first image processing apparatus; and a first processing unit configured to perform the predetermined process according to the execution instruction based on the execution information.

According to another embodiment, there is provided an image processing system that includes an image processing apparatus; an information processing apparatus configured to transmit an instruction on image processing to the image processing apparatus, the information processing apparatus being connected to the image processing apparatus via a network; and a power supply apparatus configured to supply power to the image processing apparatus, the power supply apparatus being connected to the image processing apparatus and the information processing apparatus via the network. The information processing apparatus includes an execution instruction receiving unit configured to receive an execution instruction on a predetermined process to be performed by the image processing apparatus; and a first transmitting unit configured to transmit, to the power supply apparatus, a start instruction to start power supply to the image processing apparatus, the execution instruction, and execution information needed to perform the predetermined process when the execution instruction is received. The power supply apparatus includes a first receiving unit configured to receive the start instruction, the execution instruction, and the execution information from the information processing apparatus; a power control unit configured to start power supply to the image processing apparatus when the start instruction is received; a communication monitoring unit configured to monitor whether a communication with the image processing apparatus is enabled; and a second transmitting unit configured to transmit the execution instruction and the execution information to the image processing apparatus when the communication with the image processing apparatus is enabled. The image processing apparatus includes a power control unit configured to start power supply to components of the image processing apparatus when power is supplied by the power supply apparatus; a second receiving unit configured to receive the execution instruction and the execution information from the power supply apparatus when the power supply unit starts power supply to the components unit of the image processing apparatus; and a processing unit configured to perform the predetermined process according to the execution instruction based on the execution information.

According to another embodiment, there is provided an image processing method for an image processing system that includes an image processing apparatus, an information processing apparatus that is connected to the first image processing apparatus via a network and that transmits an instruction on image processing to the image processing apparatus, and a power supply apparatus that is connected to the information processing apparatus via the network and that supplies power to the image processing apparatus. The image processing method includes receiving, by the information processing apparatus, an execution instruction on a predetermined process to be performed by the image processing apparatus; transmitting, from the information processing apparatus to the power supply apparatus, a start instruction to start power supply to the image processing apparatus when the execution instruction is received; monitoring, by the information processing apparatus, whether a communication with the image processing apparatus is enabled; transmitting, from the information processing apparatus to the image processing apparatus, the execution instruction and execution information needed to perform the predetermined process when the communication with the image processing apparatus is enabled; receiving, by the power supply apparatus, the start instruction from the information processing apparatus; starting, by the power supply apparatus, power supply to the image processing apparatus when the start instruction is received; starting, by the image processing apparatus, power supply to components of the image processing apparatus when power is supplied by the power supply apparatus; receiving, by the image processing apparatus, the execution instruction and the execution information from the information processing apparatus when power supply to the components of the image processing apparatus is started; and executing, by the image processing apparatus, the predetermined process according to the execution instruction based on the execution information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an overall configuration of an image processing system according to a first embodiment;

FIG. 2 is a sequence diagram of a process performed by the image processing system according to the first embodiment when a user inputs an execution instruction via an information processing apparatus;

FIG. 3 is a sequence diagram of a process performed by the image processing system according to the first embodiment when a power-off event occurs in an image processing apparatus;

FIG. 4 is a sequence diagram of a process performed by an image processing system according to a first modification;

FIG. 5 is a diagram illustrating an overall configuration of an image processing system according to a second embodiment;

FIG. 6 is a sequence diagram of a process performed by the image processing system according to the second embodiment when a user inputs an execution instruction via an information processing apparatus;

FIG. 7 is a diagram illustrating an overall configuration of an image processing system according to a third embodiment;

FIG. 8 is a sequence diagram of a process performed by the image processing system according to the third embodiment when a user inputs an execution instruction via an information processing apparatus;

FIG. 9 is a diagram illustrating an overall configuration of an image processing system according to a fourth embodiment;

FIG. 10 is a sequence diagram of a process performed by the image processing system according to the fourth embodiment when a power-off event occurs in a first image processing apparatus;

FIG. 11 is a sequence diagram of a process performed by the image processing system according to the fourth embodiment when a power-off event occurs in an information processing apparatus;

FIG. 12 is a network configuration diagram of an image processing system according to a fifth embodiment;

FIG. 13 is a sequence diagram of a process for detecting an image processing apparatus connected to a power supply apparatus in the fifth embodiment;

FIG. 14 is a configuration diagram in which image processing apparatuses and power supply apparatuses are connected via PLC power lines in the image processing system according to the fifth embodiment; and

FIG. 15 is a hardware configuration diagram of the image processing apparatuses according to the first to the fifth embodiments.

### DETAILED DESCRIPTION OF THE PREFERRED EMBODIMENTS

Exemplary embodiments of the present invention will be explained in detail below with reference to the accompanying drawings.

### First Embodiment

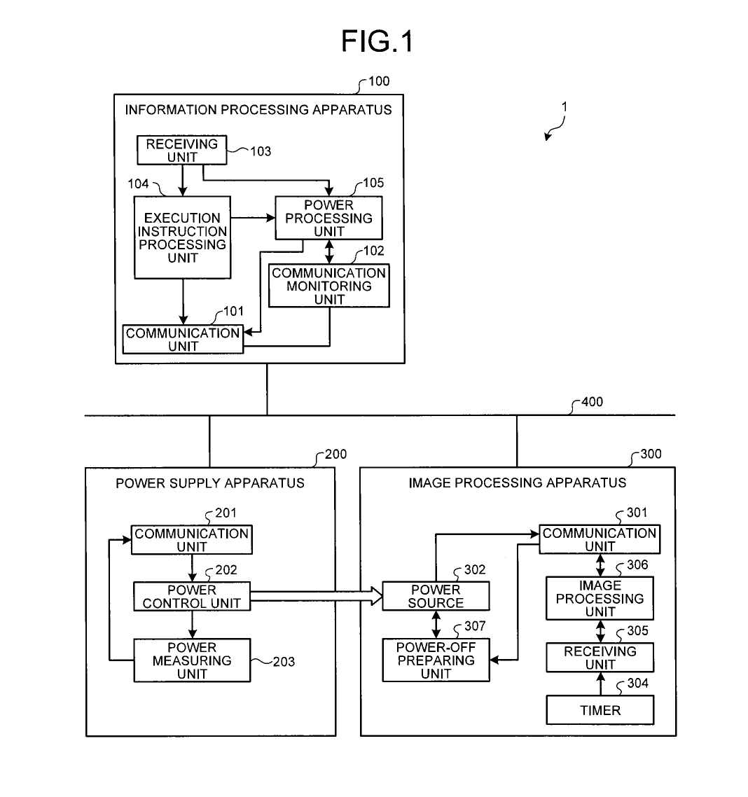

FIG. 1 is a diagram illustrating an overall configuration of an image processing system 1 according to a first embodiment. The image processing system 1 includes an information processing apparatus 100, a power supply apparatus 200, and an image processing apparatus 300. The information processing apparatus 100, the power supply apparatus 200, and the image processing apparatus 300 are connected to one another via a network 400.

The information processing apparatus 100 receives an instruction, such as a print instruction, on the image processing apparatus 300 from a user. The image processing apparatus 300 performs a process on an image in accordance with the instruction, such as the print instruction, that the user has input via the information processing apparatus 100. The power supply apparatus 200 is connected to the image processing apparatus 300 via a power line and supplies power to the image processing apparatus 300 via the power line. The power supply apparatus 200 controls on and off of the power supply to the image processing apparatus 300 in accordance with an instruction from the information processing apparatus 100 or the image processing apparatus 300. The power supply apparatus 200 may be, for example, a distribution board or a power strip. The power supply apparatus 200 can supply power to a plurality of apparatuses. However, in the first embodiment, an example will be explained in which the power supply apparatus 200 supplies power to only the image processing apparatus 300.

The information processing apparatus 100 includes a communication unit 101, a communication monitoring unit 102, a receiving unit 103, an execution instruction processing unit 104, and a power processing unit 105. The communication unit 101 communicates with the power supply apparatus 200 and the image processing apparatus 300 via the network 400.

The communication monitoring unit 102 monitors whether a communication with the image processing apparatus 300 is established. Specifically, the communication monitoring unit 102 monitors whether a communication with the image processing apparatus 300 is enabled via the network 400. The power supply apparatus 200 controls on and off of the power to the image processing apparatus 300 via the power line. When the power to the image processing apparatus 300 is off, the communication unit 101 cannot communicate with the image processing apparatus 300. Therefore, the communication monitoring unit 102 monitors whether a communication with the image processing apparatus 300 is established so that the communication unit 101 can normally communicate with the image processing apparatus 300.

The receiving unit 103 receives an input of various types of information from a user. The receiving unit 103 receives, for example, an input of an execution instruction to instruct the image processing apparatus 300 to perform a predetermined process. Examples of the execution instruction include a print instruction to instruct the image processing apparatus 300 to print predetermined image data and include a transmission instruction to transmit scan data scanned by the image processing apparatus 300 to the information processing apparatus 100 so that the scan data can be viewed in the information processing apparatus 100. The receiving unit 103 also receives an instruction to turn on or off the power to the image processing apparatus 300. The receiving unit 103 functions as an execution instruction receiving unit and a power-off instruction receiving unit.

The execution instruction processing unit 104 is, for example, a printer driver, and performs a process for transmitting the execution instruction to the image processing apparatus 300 in accordance with the execution instruction received by the receiving unit 103. For example, the execution instruction processing unit 104 generates a print job based on image data and a print instruction on the image data, and instructs the communication unit 101 to transmit the print job to the image processing apparatus 300.

The power processing unit 105 performs a process for turning on or off the power to the image processing apparatus 300. Specifically, the power processing unit 105 instructs the communication unit 101 to transmit, to the power supply apparatus 200, a start instruction to start power supply to the image processing apparatus 300. The power processing unit also instructs the communication unit 101 to transmit, to the power supply apparatus 200, a stop instruction to stop power supply to the image processing apparatus 300.

In the first embodiment, a system administrator or the like recognizes in advance the image processing apparatus 300 connected to the power supply apparatus 200 via the power line, that is, a connection relationship indicating what image processing apparatus 300 is connected to what power supply apparatus 200, and stores (sets) an ID as identification information for identifying the image processing apparatus 300 in a storage unit (not illustrated) of the information processing apparatus 100 in association with the ID of the power supply apparatus 200 connected to the image processing apparatus 300.

Therefore, when transmitting the print job to the image processing apparatus 300, the information processing apparatus 100 transmits a power-on instruction to turn on the power to the power supply apparatus 200 having the ID associated with the ID of the image processing apparatus 300 by referring to the storage unit.

When the image processing apparatus 300 connected to the power supply apparatus 200 is changed, the system administrator or the like stores the ID of the changed image processing apparatus 300 in the storage unit in association with the ID of the power supply apparatus 200.

The power supply apparatus 200 includes a communication unit 201, a power control unit 202, and a power measuring unit 203. The communication unit 201 communicates with the information processing apparatus 100 and the image processing apparatus 300 via the network 400. The power control unit 202 controls on and off of the power supply to the image processing apparatus 300 in accordance with an instruction from the information processing apparatus 100 or the image processing apparatus 300.

The power measuring unit 203 measures power supplied to the image processing apparatus 300. The measurement result obtained by the power measuring unit 203 is transmitted from the communication unit 201 to the information processing apparatus 100 or the image processing apparatus 300. A user can view or analyze the measurement result in the information processing apparatus 100 or the like.

The image processing apparatus 300 includes a communication unit 301, a power source 302, a timer 304, a receiving unit 305, an image processing unit 306, and a power-off preparing unit 307. The communication unit 301 communicates with the information processing apparatus 100 and the power supply apparatus 200 via the network 400. The power source 302 supplies power from the power supply apparatus 200 to each of the components of the image processing apparatus 300. Namely, the power source 302 functions as a power supply unit.

The timer 304 measures time. The receiving unit 305 receives an input of the execution instruction from the user. The receiving unit 305 also receives an input of an instruction to turn on or off the power source 302 from the user. The receiving unit 305 also receives an instruction to turn on or off the power source 302 from the timer 304 at a predetermined timing. The receiving unit 305 functions as a power-off instruction receiving unit. With the instruction to turn on or off the power source 302 issued by the timer 304, the image processing apparatus 300 can turn on or off the power source 302 according to a pre-set time schedule.

The image processing unit 306 performs image processing according to the execution instruction received by the receiving unit 305 or the print job received from the information processing apparatus 100 via the communication unit 301. The power-off preparing unit 307 performs a power-off preparation process for safely turning off the power when a power-off instruction to turn off the power is received by the receiving unit 305 or when the power-off instruction is received via the communication unit 301. The power-off preparation process includes a process for terminating a predetermined task being processed and a process for storing predetermined data.

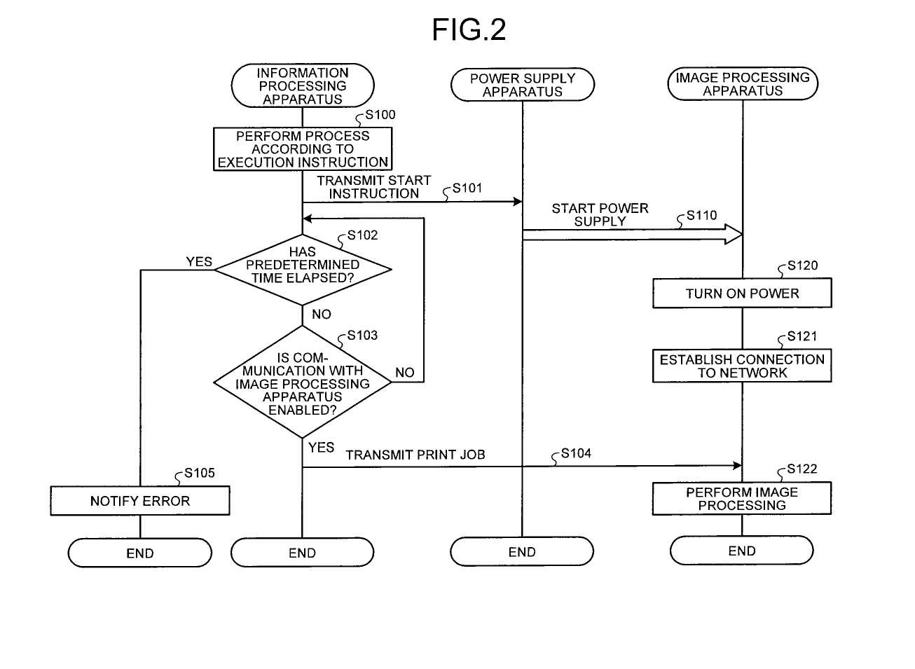

FIG. 2 is a sequence diagram of processes performed by the apparatuses of the image processing system 1 when a user inputs an execution instruction on a print process via the information processing apparatus 100. It is assumed that the power source 302 of the image processing apparatus 300 is off at the time the execution instruction is input.

In the information processing apparatus 100, when the receiving unit 103 receives the execution instruction on the print process from the user, the execution instruction processing unit 104 performs a process according to the execution instruction (Step S100). Specifically, the execution instruction processing unit 104 generates a print job based on image data to be subjected to the print process and based on the execution instruction.

The power processing unit 105 transmits a start instruction to start power supply to the image processing apparatus 300, which is an apparatus that performs a process designated by the execution instruction, to the power supply apparatus 200 via the communication unit 101 (Step S101). After the start instruction is transmitted, the communication monitoring unit 102 monitors whether a communication with the image processing apparatus 300 is established, that is, whether the communication with the image processing apparatus 300 is enabled.

In the power supply apparatus 200, when the communication unit 201 receives the start instruction from the information processing apparatus 100, the power control unit 202 starts power supply to the image processing apparatus 300 via the power line (Step S110).

In the image processing apparatus 300, when the power supply is started, the power source 302 is turned on and power is supplied from the power source 302 to each of the components of the image processing apparatus 300 (Step S120). When the power source 302 is turned on, the communication unit 301 performs a process for establishing a connection to the network 400 (Step S121).

In the information processing apparatus, before a predetermined time as a pre-set reference for timeout has elapsed (NO at Step S102), if the communication monitoring unit 102 detects that the communication with the image processing apparatus 300 is established, that is, if the communication with the image processing apparatus 300 is enabled (YES at Step S103), the communication unit 101 transmits the print job generated by the execution instruction processing unit 104 to the image processing apparatus 300 via the network (Step S104). On the other hand, at Step S103, if the communication with the image processing apparatus 300 is not established (NO at Step S103), the process returns to Step S102.

At Step S102, if the predetermined time has elapsed before the communication monitoring unit 102 of the information processing apparatus 100 detects that the communication with the image processing apparatus 300 is enabled (YES at Step S102), the communication monitoring unit 102 notifies a user of an error via a user interface, such as a display unit (not illustrated) (Step S105).

In the image processing apparatus 300, when the communication unit 301 receives the print job from the information processing apparatus 100, the image processing unit 306 performs image processing based on the print job (Step S122). Specifically, the image processing unit 306 prints an image. Thus, the process performed by the image processing system 1 is completed.

In this way, in the image processing system 1 according to the first embodiment, when the execution instruction on a predetermined process to be performed by the image processing apparatus 300 is input by a user via the information processing apparatus 100, the power source 302 of the image processing apparatus 300 is automatically turned on under the control of the power supply apparatus 200, and, after the power source 302 is turned on, the information processing apparatus 100 automatically transmits the print job. Specifically, even when the image processing apparatus 300 is in the standby state and the power supply to a part of the image processing apparatus 300 including a power supply for a network connection is suspended, the image processing apparatus 300 can start a process according to the execution instruction input by the user via the information processing apparatus 100. Therefore, it becomes possible to eliminate the power consumption for maintaining the image processing apparatus 300 in the standby state, enabling to conserve power.

Furthermore, a user can input a desired execution instruction via the information processing apparatus 100 regardless of whether the power source 302 of the image processing apparatus 300 is on or off. Therefore, it becomes possible to execute a process according to the execution instruction of the image processing apparatus 300 by a simple operation regardless of whether the power source 302 is on or off. Moreover, it is not necessary to install PoE. Therefore, it becomes possible to realize a structure that automatically turns on the image processing apparatus 300 at low costs.

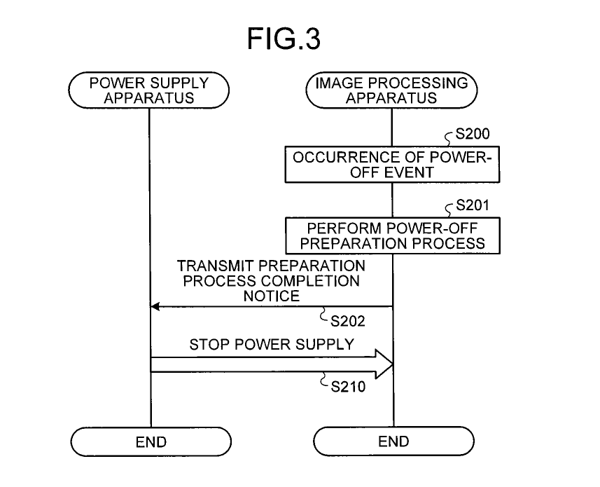

FIG. 3 is a sequence diagram of processes performed by the apparatuses of the image processing system 1 when a power-off event that causes the power source 302 to be turned off occurs in the image processing apparatus 300. Examples of the power-off event include an event in which the receiving unit 305 receives an input of the power-off instruction from a user, an event in which the timer 304 measures a pre-set time at which the power is turned off and the receiving unit 305 receives the power-off instruction from the timer 304, and an event in which the communication unit 301 receives the power-off instruction from the information processing apparatus 100.

As illustrated in FIG. 3, when the power-off event occurs in the image processing apparatus 300 (Step S200), the power-off preparing unit 307 performs the power-off preparation process as a process for safely turning off the power (Step S201).

The power-off preparation process is a process for preventing damage on a storage medium or data corruption due to a sudden power off. The power-off preparation process includes, for example, a process for issuing a stop command to a hard disk drive (HDD) to stop rotation of a disk or a process for issuing a stop-write command to a flash memory to stop writing. However, the power-off preparation process is not limited to the above processes.

In this way, by performing the power-off preparation process before the power is turned off, it becomes possible to prevent damage on a nonvolatile memory or a HDD of the image processing apparatus 300 to be described later or to prevent data corruption. If the image processing apparatus 300 does not include a device that may be damaged, it may be possible to omit the power-off preparation process.

When the power-off preparing unit 307 of the image processing apparatus 300 completes the power-off preparation process, the communication unit 301 transmits, to the power supply apparatus 200 via the network 400, a preparation process completion notice indicating that the power-off preparation process is completed (Step S202). In the power supply apparatus 200, when the communication unit 201 receives the preparation process completion notice, the power control unit 202 stops power supply to the image processing apparatus 300 via the power line (Step S210). Thus, the power-off process is completed.

In this way, in the image processing system 1 according to the first embodiment, it is possible to turn off the power source 302 of the image processing apparatus 300 under the control of the power supply apparatus 200 even when the image processing apparatus 300 does not include a power-off unit, such as a relay. Therefore, it becomes possible to realize a structure for automatically turning off the power source 302 of the image processing apparatus 300 at low costs. Furthermore, even when the image processing apparatus 300 is completely turned off through the processes explained above with reference to FIG. 3, if the execution instruction is input by a user via the information processing apparatus 100, the power supply apparatus 200 can automatically turn on the power source 302 of the image processing apparatus 300 through the processes explained above with reference to FIG. 2.

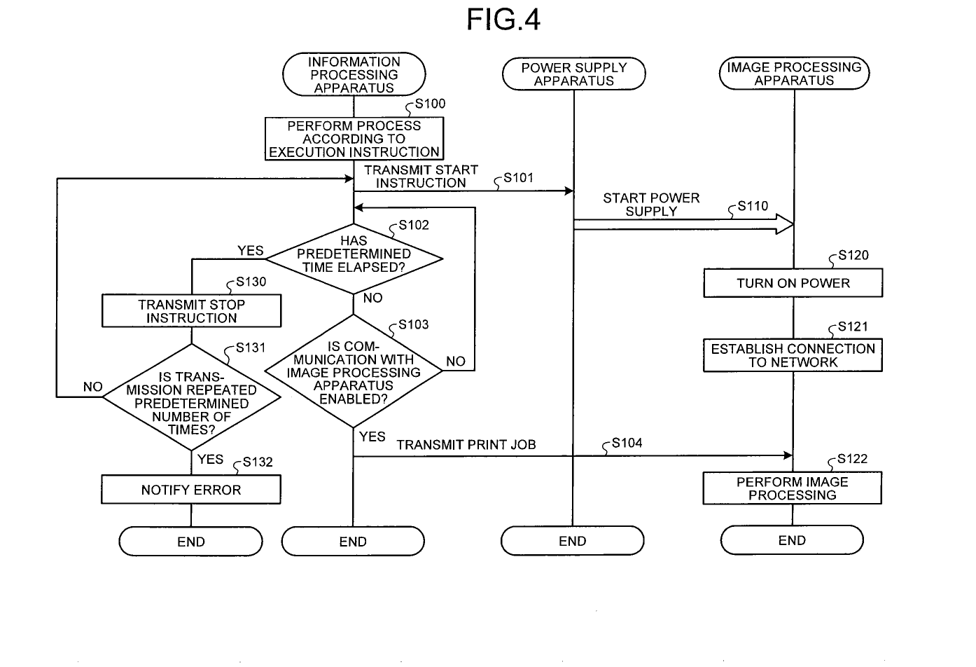

FIG. 4 is a sequence diagram of a process performed by the image processing system 1 according to a first modification. In the first modification, if a communication with the image processing apparatus 300 is not established even after the predetermined time has elapsed at Step S102, the power source 302 of the image processing apparatus 300 is turned off once and turned on again to wait for the communication with the image processing apparatus 300 to be established

Specifically, at Step S102, when the predetermined time has elapsed (YES at Step S102), the communication monitoring unit 102 transmits a stop instruction to stop power supply to the image processing apparatus 300 to the power supply apparatus 200 via the communication unit 101 (Step S130). In this case, in the power supply apparatus 200, the communication unit 201 receives the stop instruction and the power control unit 202 stops power supply to the image processing apparatus 300.

In the information processing apparatus 100, when the process for transmitting the start instruction at Step S101 and the process for transmitting the stop instruction at Step S131 are not repeated a predetermined number of times at Step S131 (NO at Step S131), the process returns to Step S101 and the power processing unit 105 transmits the start instruction again to the power supply apparatus 200 via the communication unit 101 (Step S101). Then, the process goes to Step S103, and the communication monitoring unit 102 monitors whether a communication with the image processing apparatus 300 is established. On the other hand, at Step S131, when the process for transmitting the stop instruction is repeated the predetermined number of times (YES at Step S131), the communication monitoring unit 102 issues a notice of an error (Step S132). The processes other than the above performed by the image processing system 1 are the same as those explained above with reference to FIG. 2.

As described above, when the communication with the image processing apparatus 300 is not established after the predetermined time has elapsed at Step S102, the information processing apparatus 100 turns off the power source 302 of the image processing apparatus 300 once and turns on the power source 302 again to wait for the communication with the image processing apparatus 300 to be established. Therefore, when the power is supplied from the power supply apparatus 200 to the image processing apparatus 300 and the power source 302 is turned on, and if the image processing apparatus 300 does not normally operate, because the power source 302 is turned off once and turned on again, it becomes possible to normally operate the image processing apparatus 300.

### Second Embodiment

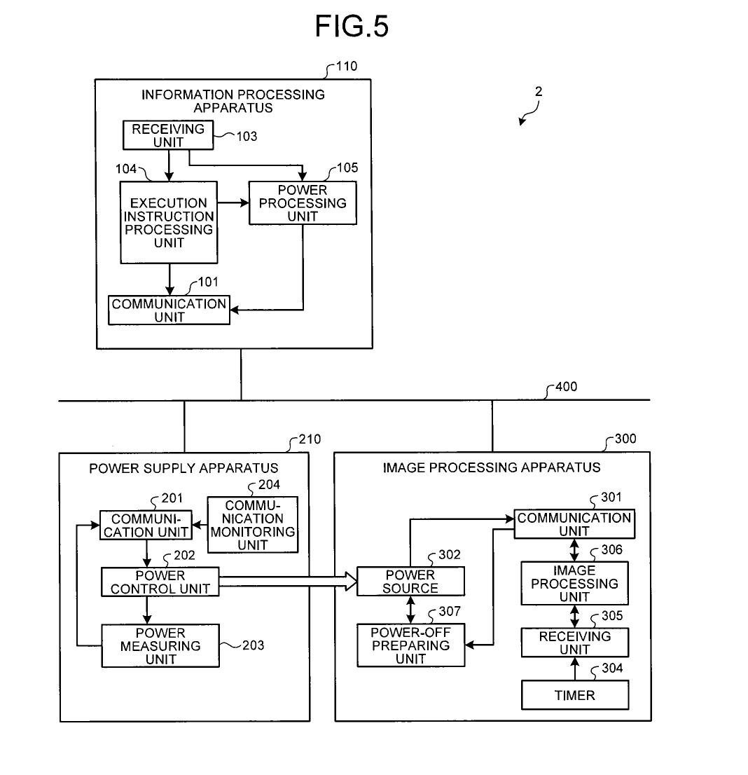

FIG. 5 is a diagram illustrating an overall configuration of an image processing system 2 according to a second embodiment. Similarly to the first embodiment, an information processing apparatus 110, a power supply apparatus 210, and the image processing apparatus 300 are connected to one another via the network 400, and the power supply apparatus 210 and the image processing apparatus 300 are connected to each other via a power line.

In the image processing system 2 according to the second embodiment, the information processing apparatus 110 does not include the communication monitoring unit 102, and the power supply apparatus 210 includes a communication monitoring unit 204.

The execution instruction processing unit 104 of the information processing apparatus 110 instructs the communication unit 101 to transmit a print job, which is generated according to the execution instruction received by the receiving unit 103, to the power supply apparatus 210. The communication monitoring unit 204 of the power supply apparatus 210 monitors whether a communication with the image processing apparatus 300 is established. The other functional configurations of the information processing apparatus 110, the power supply apparatus 210, and the image processing apparatus 300 are the same as those of the information processing apparatus 100, the power supply apparatus 200, and the image processing apparatus 300 according to the first embodiment, respectively.

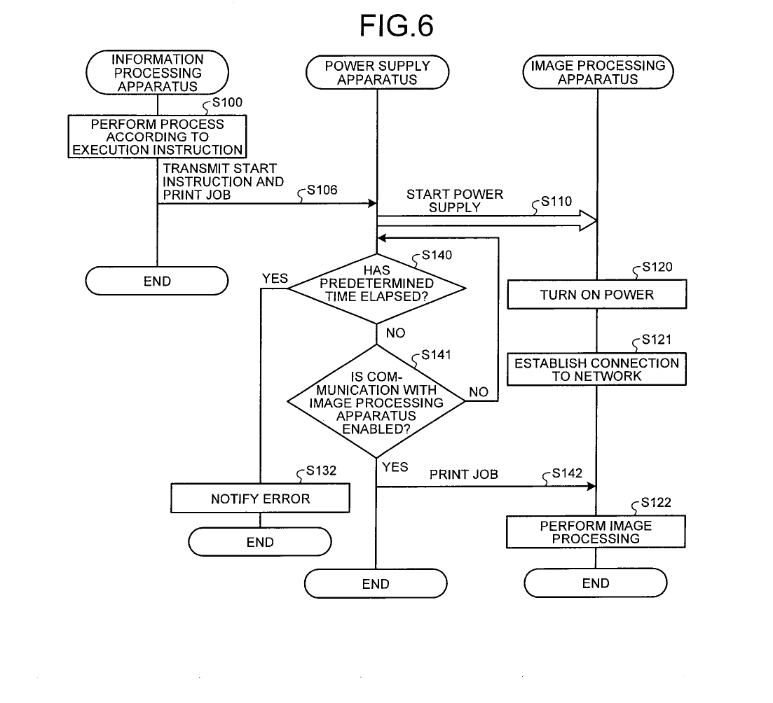

FIG. 6 is a sequence diagram of processes performed by the apparatuses of the image processing system 2 when a user inputs an execution instruction on a print process via the information processing apparatus 110. In the information processing apparatus 110, when the receiving unit 103 receives the execution instruction on the print process from the user, the execution instruction processing unit 104 performs a process according to the execution instruction and generates a print job (Step S100). Subsequently, the communication unit 101 transmits the print job, the transmission of which is instructed by the execution instruction processing unit 104, and the start instruction, the transmission of which is instructed by the power processing unit 105, to the power supply apparatus 210 (Step S106).

In this way, according to the second embodiment, the information processing apparatus 110 transmits, to the power supply apparatus 210 not to the image processing apparatus 300, the start instruction and the print job which contains the execution instruction and execution information containing all information needed to cause the image processing apparatus 300 to perform a process according to the execution instruction. Therefore, the information processing apparatus 110 can finish the process according to the execution instruction at Step S106 without waiting for the communication with the image processing apparatus 300 to be established.

In the power supply apparatus 210, when the communication unit 201 receives the start instruction and the print job from the information processing apparatus 110, the power control unit 202 starts power supply to the image processing apparatus 300 via the power line (Step S110). The communication monitoring unit 204 monitors whether a communication with the image processing apparatus 300 via the network 400 is established. When the communication monitoring unit 204 detects, before the predetermined time has elapsed (NO at Step S140), that the communication with the image processing apparatus 300 is established, that is, when the communication with the image processing apparatus 300 via the network 400 is enabled (YES at Step S141), the communication unit 201 transmits the print job received from the information processing apparatus 110 to the image processing apparatus 300 via the network 400 (Step S142). The processes other than the above are the same as the processes performed by the image processing system 1 in the first embodiment explained above with reference to FIG. 2.

### Third Embodiment

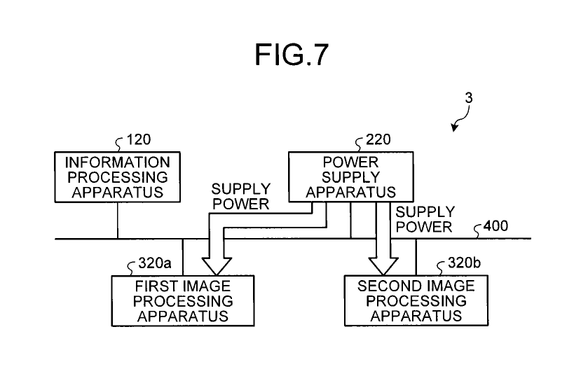

FIG. 7 is a diagram illustrating an overall configuration of an image processing system 3 according to a third embodiment. The image processing system 3 according to the third embodiment includes two image processing apparatuses, that is, a first image processing apparatus 320a and a second image processing apparatus 320b. A power supply apparatus 220 is connected to both of the image processing apparatuses 320a and 320b via respective power lines, and controls power supply to the image processing apparatuses 320a and 320b via the power lines. An information processing apparatus 120, the power supply apparatus 220, and the image processing apparatuses 320a and 320b are connected to one another via the network 400.

In the third embodiment, the first image processing apparatus 320a or the second image processing apparatus 320b performs a process according to the execution instruction received by the receiving unit 103 of the information processing apparatus 120. The communication monitoring unit 102 of the information processing apparatus 120 monitors whether the image processing apparatuses 320a and 320b are connected to the network 400. The power processing unit 105 performs a process for turning on or off the power of the image processing apparatuses 320a and 320b.

The power control unit 202 of the power supply apparatus 220 controls on and off of the power supply to the image processing apparatuses 320a and 320b via the power lines. The power measuring unit 203 measures the power supplied to the image processing apparatuses 320a and 320b and transmits measurement results to the information processing apparatus 120 or the image processing apparatuses 320a and 320b.

The other functional configurations of the information processing apparatus 120 and the power supply apparatus 220 are the same as those of the information processing apparatus 100 and the power supply apparatus 200 according to the first embodiment, respectively. The functional configurations of each of the image processing apparatuses 320a and 320b are the same as those of the image processing apparatus 300 according to the first embodiment.

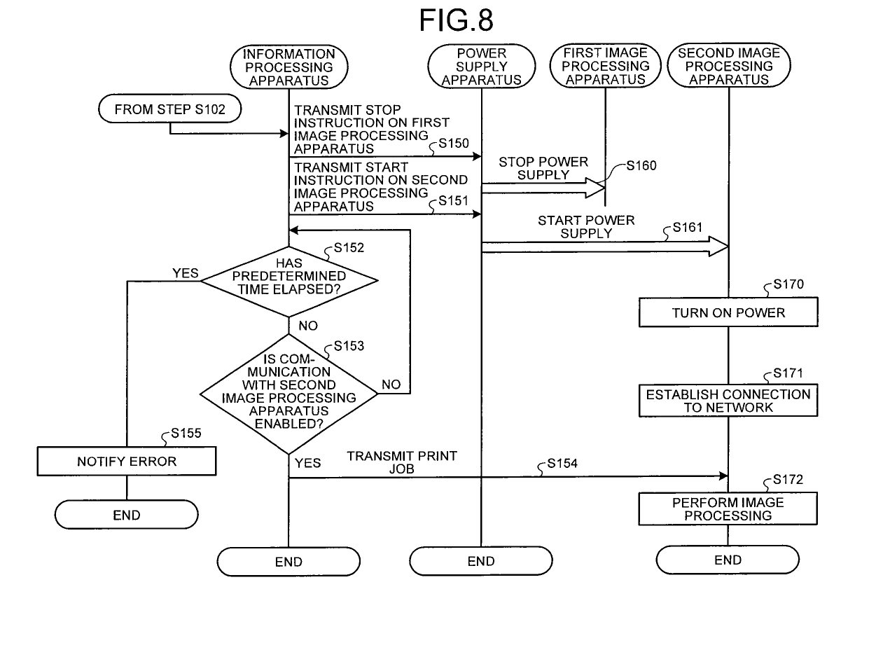

FIG. 8 is a sequence diagram of a process performed by the image processing system 3 when a user inputs an execution instruction via the information processing apparatus 120. It is assumed that the power to the image processing apparatuses 320a and 320b is off when the execution instruction is input.

FIG. 8 illustrates processes to be performed when the predetermined time has elapsed (YES at Step S102) before the information processing apparatus 100 detects establishment of the communication with the image processing apparatus 300 at Step S102 in FIG. 2 explained above in the first embodiment. Specifically, at Step S102 in FIG. 2, when the predetermined time has elapsed (YES at Step S102), the process goes to Step S150 in FIG. 8. In the image processing system 3 according to the third embodiment, the first image processing apparatus 320a performs the process that is performed by the image processing apparatus 300 in FIG. 2. Furthermore, the communication with the image processing apparatus 300 in FIG. 2 corresponds to a communication with the second image processing apparatus 320b in the image processing system 3 according to the third embodiment.

At Step S102, when the predetermined time has elapsed (YES at Step S102), the power processing unit 105 transmits a stop instruction to stop power supply to the first image processing apparatus 320a to the power supply apparatus 220 via the communication unit 101 (Step S150). The power processing unit 105 also transmits a start instruction to start power supply to the second image processing apparatus 320b to the power supply apparatus 220 via the communication unit 101 (Step S151).

In the power supply apparatus 220, when the communication unit 201 receives, from the information processing apparatus 120, the stop instruction on the first image processing apparatus 320a and the start instruction on the second image processing apparatus 320b, the power control unit 202 stops power supply to the first image processing apparatus 320a (Step S160) and starts power supply to the second image processing apparatus 320b via the power line (Step S161).

Therefore, the first image processing apparatus 320a is turned off. On the other hand, in the second image processing apparatus 320b, when the power supply is started, the power source 302 is turned on and the power is supplied to each of the components of the second image processing apparatus 320b (Step S170). When the power is turned on, the communication unit 301 performs a process for establishing a connection to the network 400 (Step S171).

In the information processing apparatus 120, the same processes as the processes performed on the image processing apparatus 300 at Step S102 to Step S105 in FIG. 2 are performed on the second image processing apparatus 320b. Specifically, when, before the predetermined time has elapsed (NO at Step S152), the communication monitoring unit 102 of the information processing apparatus 120 detects establishment of the communication with the second image processing apparatus 320b (YES at Step S153), the communication unit 101 transmits the print job generated by the execution instruction processing unit 104 to the second image processing apparatus 320b via the network 400 (Step S154).

At Step S152, when the predetermined time has elapsed before the communication monitoring unit 102 of the information processing apparatus 120 detects establishment of the communication with the second image processing apparatus 320b (YES at Step S152), the communication monitoring unit 102 notifies a user of an error via a user interface, such as a display unit (not illustrated) (Step S155).

In the second image processing apparatus 320b, when the communication unit 301 receives the print job from the information processing apparatus 120, the image processing unit 306 performs image processing based on the print job (Step S172). Specifically, the image processing unit 306 prints an image. Thus, the processes performed by the image processing system 3 are completed.

In this way, in the image processing system 3 according to the third embodiment, when the communication with the first image processing apparatus 320a is not established, it is possible to turn on the power source 302 of the second image processing apparatus 320b, which is an image processing apparatus connected to the network 400 other than the first image processing apparatus 320a, establish a communication between the information processing apparatus 120 and the second image processing apparatus 320b, and cause the second image processing apparatus 320b to perform a process, in cooperation with the information processing apparatus 120 and the power supply apparatus 220.

Therefore, even when the communication between the information processing apparatus 120 and the first image processing apparatus 320a is not established for some reason, the information processing apparatus 120 can establish the communication with the second image processing apparatus 320b, and the second image processing apparatus 320b can perform a process desired by a user.

### Fourth Embodiment

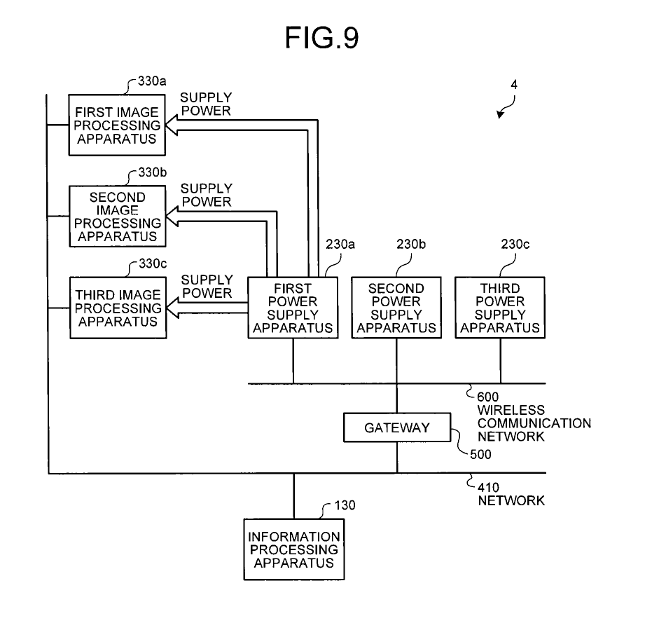

FIG. 9 is a diagram illustrating an overall configuration of an image processing system 4 according to a fourth embodiment. The image processing system 4 includes an information processing apparatus 130, a first power supply apparatus 230a, a second power supply apparatus 230b, a third power supply apparatus 230c, a first image processing apparatus 330a, a second image processing apparatus 330b, a third image processing apparatus 330c, and a gateway 500. The number of the image processing apparatuses and the power supply apparatuses included in the image processing system 4 is not limited by the fourth embodiment.

In the image processing system 4, the image processing apparatuses 330a to 330c and the information processing apparatus 130 are connected to one another via a network 410. The power supply apparatuses 230a to 230c are connected to a wireless communication network 600. The network 410 and the wireless communication network 600 are connected to each other via the gateway 500. The wireless communication network 600 may be, for example, ZigBee (registered trademark). Alternatively, for example, the power supply apparatuses 230a to 230c may be connected to a wired communication network connected to the gateway 500 instead of the wireless communication network 600.

Each of the power supply apparatuses 230a to 230c is connected to all the image processing apparatuses 330a to 330c via power lines. Each of the power supply apparatuses 230a to 230c supplies power to all the image processing apparatuses 330a to 330c via the power lines. In FIG. 9, it is indicated that the first power supply apparatus 230a supplies power to all the image processing apparatuses 330a to 330c via the respective power lines, and the same applies to the second power supply apparatus 230b and the third power supply apparatus 230c although not illustrated as such.

In the fourth embodiment, the information processing apparatus 130 communicates with the power supply apparatuses 230a to 230c via the gateway 500. Meanwhile, the image processing apparatuses 330a to 330c perform communications only via the network 410 and do not directly communicate with the power supply apparatuses 230a to 230c. Therefore, it is sufficient that the gateway 500 can control the information processing apparatus 130 and it becomes possible to prevent the processes of the image processing apparatuses 330a to 330c from becoming complicated.

The communication unit 101 of the information processing apparatus 130 communicates with the image processing apparatuses 330a to 330c via the network 410. The communication unit 101 of the information processing apparatus 130 also communicates with the power supply apparatuses 230a to 230c via the network 410 and the wireless communication network 600. The other functional configurations of the information processing apparatus 130 are the same as those of the information processing apparatus 100 of the first embodiment explained above with reference to FIG. 1.

The functional configurations of each of the power supply apparatuses 230a to 230c are the same as those of the power supply apparatus 200 of the first embodiment explained above with reference to FIG. 1. The functional configurations of each of the image processing apparatuses 330a to 330c are the same as those of the image processing apparatus 300 of the first embodiment explained above with reference to FIG. 1. In the fourth embodiment, the first power supply apparatus 230a controls power supply to the image processing apparatuses 330a to 330c and performs a process for, for example, measuring power supplied to the image processing apparatuses 330a to 330c.

In the image processing system 4, similarly to the other embodiments described above, when a user inputs an execution instruction via the information processing apparatus 130, the power source 302 of a predetermined one of the image processing apparatuses 330a to 330c is turned on, and an instruction desired by the user is executed. Besides, even in the image processing system 4, any of the image processing apparatuses 330a to 330c being turned on can be turned off at an appropriate timing.

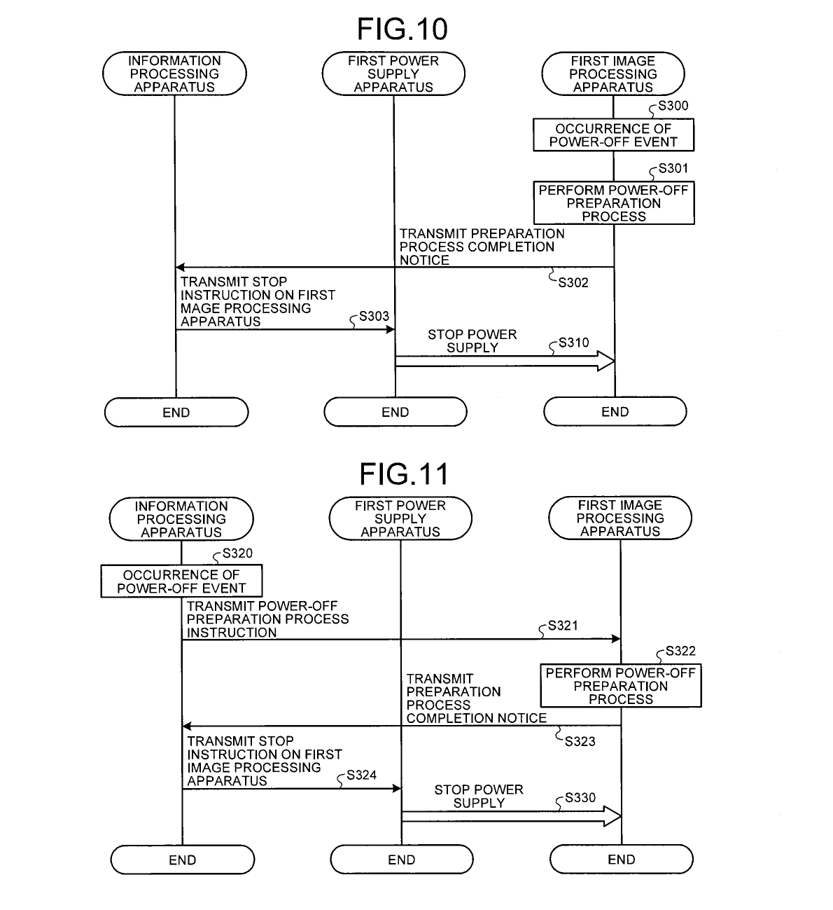

FIG. 10 is a sequence diagram of processes performed by the apparatuses of the image processing system 4 when the power-off event occurs in the first image processing apparatus 330a. When the power-off event occurs in the first image processing apparatus 330a (Step S300), the power-off preparing unit 307 of the first image processing apparatus 330a performs a power-off preparation process (Step S301). Subsequently, the power-off preparing unit 307 of the first image processing apparatus 330a transmits a preparation process completion notice indicating that the power-off preparation process is completed to the information processing apparatus 130 via the communication unit 301 (Step S302).

When the communication unit 101 of the information processing apparatus 130 receives the preparation process completion notice, the power processing unit 105 transmits a stop instruction to stop power supply to the first image processing apparatus 330a to the first power supply apparatus 230a via the communication unit 101 (Step S303).

When the communication unit 201 of the first power supply apparatus 230a receives the stop instruction on the first image processing apparatus 330a from the information processing apparatus 130, the power control unit 202 stops power supply to the first image processing apparatus 330a via the power line (Step S310). Thus, the processes performed by the image processing system 4 are completed.

In this way, in the image processing system 4 according to the fourth embodiment, when the power-off event occurs in the first image processing apparatus 330a, the first image processing apparatus 330a can cause the first power supply apparatus 230a to stop power supply to the first image processing apparatus 330a via the information processing apparatus 130 connected to the same network 410. Therefore, even when the first image processing apparatus 330a and the first power supply apparatus 230a cannot directly communicate with each other, it is possible to turn off the first image processing apparatus 330a via the information processing apparatus 130.

In FIG. 10, a case is explained in which the power-off event occurs in the first image processing apparatus 330a. However, the same applies to a case in which the power-off event occurs in the other image processing apparatuses 330b and 330c.

FIG. 11 is a sequence diagram of processes performed by the apparatuses of the image processing system 4 when a power-off event that causes the first image processing apparatus 330a to be turned off occurs in the information processing apparatus 130. Examples of the power-off event that causes the first image processing apparatus 330a to be turned off and that occurs in the information processing apparatus 130 include an event in which the receiving unit 103 receives an input of a power-off instruction to turn off the first image processing apparatus 330a from a user, and an event in which a timer (not illustrated) of the information processing apparatus 130 detects a time at which the power is turned off and the receiving unit 103 receives the power-off instruction from the timer.

As illustrated in FIG. 11, when the power-off event occurs in the information processing apparatus 130 (Step S320), the power processing unit 105 of the information processing apparatus 130 transmits a power-off preparation process instruction to perform the power-off preparation process to the first image processing apparatus 330a via the communication unit 101 (Step S321).

When the communication unit 301 of the first image processing apparatus 330a receives the power-off preparation process instruction, the power-off preparing unit 307 performs the power-off preparation process (Step S322). When the power-off preparation process is completed, the power-off preparing unit 307 transmits a preparation process completion notice indicating that the power-off preparation process is completed to the information processing apparatus 130 via the communication unit 301 (Step S323).

In the information processing apparatus 130, when the communication unit 101 receives the preparation process completion notice, the power processing unit 105 transmits the stop instruction to stop power supply to the first image processing apparatus 330a to the first power supply apparatus 230a via the communication unit 101 (Step S324).

In the first power supply apparatus 230a, when the communication unit 201 receives the stop instruction on the first image processing apparatus 330a, the power control unit 202 stops power supply to the first image processing apparatus 330a via the power line (Step S330). Thus, the processes performed by the image processing system 4 are completed.

In this way, when the power-off event occurs in the information processing apparatus 130, the first image processing apparatus 330a is caused to perform the power-off preparation process and thereafter the power source 302 of the first image processing apparatus 330a is turned off. Therefore, it becomes possible to automatically and safely turn off the image processing apparatus without causing a user to perform a predetermined operation on the image processing apparatus to be turned off, before the image processing apparatus is actually turned off.

In FIG. 11, a case is explained in which the power-off event that causes the first image processing apparatus 330a to be turned off occurs in the information processing apparatus 130. Incidentally, processes to be performed when a power-off event that causes the other image processing apparatuses 330b and 330c to be turned off occurs in the information processing apparatus 130 are the same as the above processes explained with reference to FIG. 11.

Furthermore, in the fourth embodiment, when the image processing apparatuses 330a to 330c attempt printing but cannot start up normally, it may be possible to turn the image processing apparatuses 330a to 330c off and on again and transmit a print job from the information processing apparatus 130 to the image processing apparatuses 330a to 330c again. Alternatively, it may be possible to turn on a different one of the image processing apparatuses 330a to 330c and cause the image processing apparatus that has been turned on to perform the printing. When a different one of the image processing apparatuses 330a to 330c is caused to perform printing as described above, it is preferable to notify a user that the printing is performed by the different image processing apparatus.

### Fifth Embodiment

In the first to the fourth embodiments, the power supply apparatus and the image processing apparatus are connected to each other via the network and the power line used for power supply. However, in a fifth embodiment, the power supply apparatus and the image processing apparatus are connected to each other via a power communication line that enables information transmission and power supply.

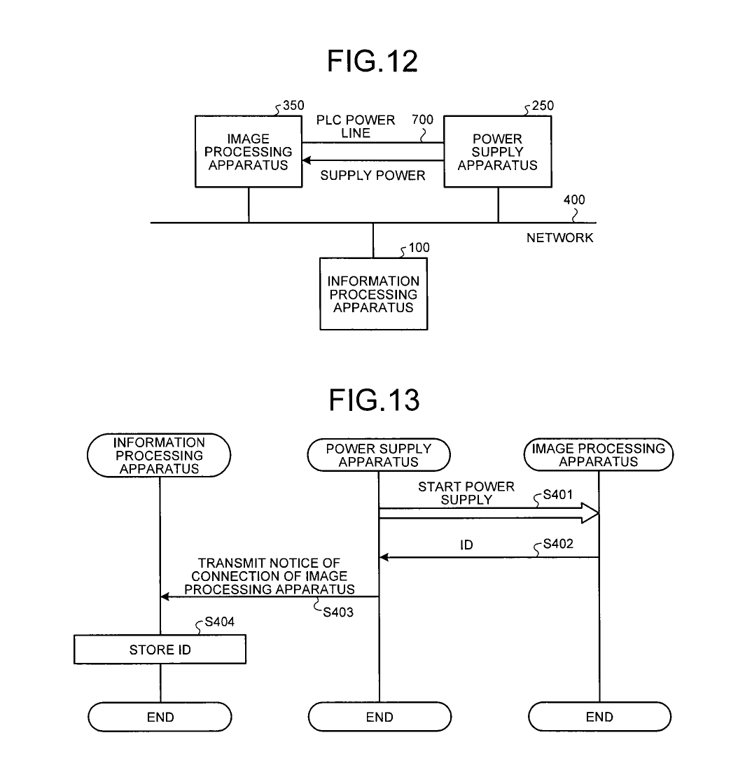

FIG. 12 is a network configuration diagram of an image processing system according to the fifth embodiment. In the image processing system according to the fifth embodiment, as illustrated in FIG. 12, an image processing apparatus 350, a power supply apparatus 250, and the information processing apparatus 100 are connected to one another via the network 400. In the fifth embodiment, the image processing apparatus 350 and the power supply apparatus 250 are connected to each other via a power line communication (PLC)-based power line serving as a power communication line that enables, as a power-saving communication unit, information transmission and power supply.

PLC is a technology for using a power line as a communication line. Specifically, PLC is a system for carrying an information signal with an electrical signal flowing through the power line to enable a bidirectional communication. Hereinafter, a power line 700 based on PLC is simply described as the PLC power line 700.

In the fifth embodiment, a PLC adapter is provided in each of the power supply apparatus 250 and the image processing apparatus 350, and the PLC adapters are connected to each other via the PLC power line 700. Therefore, the power supply apparatus 250 and the image processing apparatus 350 are connected to each other via the PLC power line 700.

The power control unit 202 of the power supply apparatus 250 according to the fifth embodiment supplies power to the image processing apparatus 350 via the PLC power line 700. The communication unit 201 of the power supply apparatus 250 and the communication unit 301 of the image processing apparatus 350 can bidirectionally transmit and receive various types of information via the PLC power line 700.

The other functional configurations of the power supply apparatus 250 and the image processing apparatus 350 are the same as those of the first embodiment. Furthermore, the functional configurations of the information processing apparatus 100 are the same as those of the first embodiment.

In the fifth embodiment, because the power supply apparatus 250 and the image processing apparatus 350 are connected to each other via the PLC power line 700, the information processing apparatus 100 can detect what image processing apparatus 350 is connected to what power supply apparatus 250 without manual operations performed by a system administrator.

FIG. 13 is a sequence diagram of a process for detecting the image processing apparatus 350 connected to the power supply apparatus 250 in the fifth embodiment. When the power control unit 202 of the power supply apparatus 250 supplies power to the image processing apparatus 350 via the PLC power line 700 (Step S401), the communication unit 301 of the image processing apparatus 350 transmits an ID, as identification information on the image processing apparatus 350, to the power supply apparatus 250 via the PLC power line 700 (Step S402).

In the power supply apparatus 250, the communication unit 201 receives the ID from the image processing apparatus 350 via the PLC power line 700. The communication unit 201 transmits a notice of connection of the image processing apparatus 350, which contains the received ID of the image processing apparatus 350 and the ID of the power supply apparatus 250, to the information processing apparatus 100 via the network 400 (Step S403).

In the information processing apparatus 100, the communication unit 101 receives the notice of connection of the image processing apparatus 350 from the power supply apparatus 250 via the network 400. The communication unit 101 stores the ID of the image processing apparatus 350 and the ID of the power supply apparatus 250, which are contained in the received notice of connection, in the storage unit (not illustrated) in an associated manner (Step S404).

In this way, according to the fifth embodiment, the power supply apparatus 250 and the image processing apparatus 350 are connected to each other via the PLC power line 700 that is a power-saving communication unit.

Therefore, in addition to achieving the same advantageous effects as those of the first to the fourth embodiments, the information processing apparatus 100 can automatically detect a connection relationship indicating what power supply apparatus 250 is connected to what image processing apparatus 350. Consequently, it is not necessary for a system administrator or the like to set the connection relationship in advance, so that the operating efficiency can be enhanced.

Furthermore, in the fifth embodiment, when a power-on event occurs in the image processing apparatus 350, the communication unit 301 of the image processing apparatus 350 directly transmits a power-on instruction to turn on the power to the power supply apparatus 250 via the PLC power line 700. In the power supply apparatus 250, when the communication unit 201 receives the power-on instruction from the image processing apparatus 350 via the PLC power line 700, the power control unit 202 supplies power to the image processing apparatus 350 via the PLC power line 700 as in the process at Step S401.

A case will be explained below in which the PLC power line 700 is used when the processes according to the first to the fourth embodiments are performed in the fifth embodiment.

The process for starting the power supply at Step S110 in FIGS. 2, 4, and 6 and at Step S161 in FIG. 8, and the process for stopping the power supply at Step S210 in FIG. 3, at Step S160 in FIG. 8, and at Step S330 in FIG. 11 are performed via the PLC power line 700.

The process for transmitting the preparation process completion notice from the image processing apparatus 350 to the power supply apparatus 250 at Step S202 in FIG. 3, and the process for transmitting the print job from the power supply apparatus 250 to the image processing apparatus 350 at Step S142 in FIG. 6 are performed via the PLC power line 700.

In the same configuration as the overall configuration of the image forming system according to the fourth embodiment illustrated in FIG. 9, it may be possible to connect the image forming apparatuses and the power supply apparatuses via the PLC power lines 700.

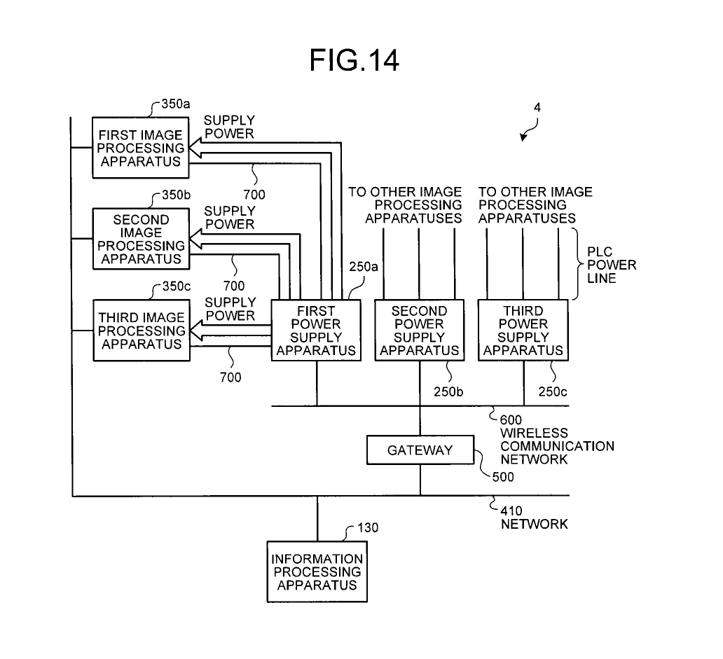

FIG. 14 is a diagram illustrating a configuration in which the image processing apparatuses and the power supply apparatuses of the image processing system according to the fifth embodiment are connected to one another via the PLC power lines 700.

In this case, when the power-off event occurs in a first image processing apparatus 350a, the first image processing apparatus 350a performs the power-off preparation process, and thereafter, the communication unit 301 of the first image processing apparatus 350a directly transmits the preparation process completion notice to a first power supply apparatus 250a via the PLC power line 700. Consequently, the first power supply apparatus 250a can be notified that the first image processing apparatus 350a has completed the power-off preparation process without via the information processing apparatus 130, and the power control unit 202 of the first power supply apparatus 250a can stop power supply to the first image processing apparatus 350a.

Therefore, it becomes possible to eliminate a process that is performed via the information processing apparatus 130, such as a process as illustrated in FIG. 10 in which, to cause the first power supply apparatus 250a to stop power supply to the first image processing apparatus 350a, the completion notice of the power-off preparation process is transmitted from the first image processing apparatus 350a to the information processing apparatus 130 via a network 410 and the stop instruction is transmitted from the information processing apparatus 130 to the first power supply apparatus 250a.

In particular, in the fourth embodiment in which the PLC power line 700 is not used, a communication processing program is needed for executing communication processing among the first image processing apparatus 350a, the first power supply apparatus 250a, and the information processing apparatus 130. However, the communication processing program for a three-way communication is used only to transmit the completion notice of the power-off preparation process as described above. Therefore, the software development efficiency may be reduced.

By contrast, in the fifth embodiment, the first image processing apparatus 350a directly transmits the completion notice of the power-off preparation process to the first power supply apparatus 250a by using the PLC power line 700, so that the information processing apparatus 130 need not perform intervening operations. Therefore, the less-frequently used communication processing program for the first image processing apparatus 350a, the first power supply apparatus 250a, and the information processing apparatus 130 is not needed and the software efficiency can be enhanced.

In the first to the fifth embodiments, the networks 400 and 410 are used. However, it may be possible to use other communication units instead of the network 400. For example, it may be possible to use a wireless local area network (LAN) instead of the network 400.

Furthermore, in the fifth embodiment, the power supply apparatus 250 and the image processing apparatus 350 are connected to each other via the PLC power line 700; however, the present invention is not limited to this. For example, the power supply apparatus 250 and the image processing apparatus 350 may be connected to each other via an infrared communication, a radio frequency (RF) wireless communication, or other near field communication (NFC). In this case, however, the power supply apparatus 250 and the image processing apparatus 350 need to be connected to each other also by a power line for enabling power supply.

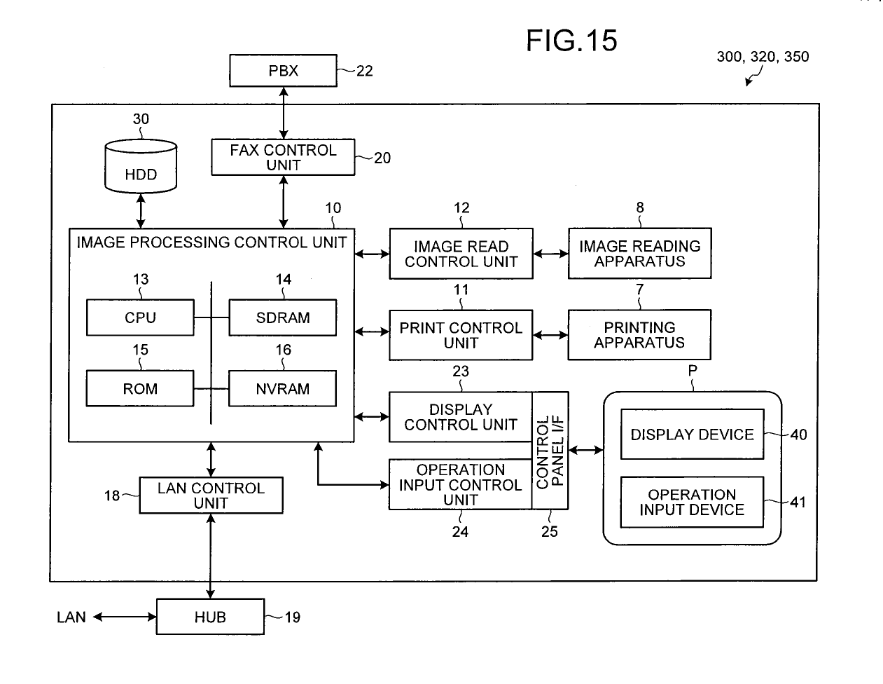

FIG. 15 is a block diagram of a hardware configuration of the image processing apparatus 300, 320 (320a or 320b), or 350 (350a, 350b, or 350c) according to the first to the fifth embodiments. The hardware configuration in FIG. 15 is based on the assumption that the image processing apparatus is a multifunction peripheral.

The image processing apparatus 300, 320, or 350 includes a printing apparatus 7, an image reading apparatus 8, and an image processing control unit 10 that controls the entire image processing performed by the image processing apparatus 300, 320, or 350. To the image processing control unit 10, a print control unit 11 that controls the printing apparatus 7 and an image read control unit 12 that controls the image reading apparatus 8 are connected.

The print control unit 11 outputs a print instruction containing image data to the printing apparatus 7 under the control of the image processing control unit 10, and causes the printing apparatus 7 to form an image on a medium, such as a sheet of paper (for example, a recording medium, such as a plain paper popularly used, a color paper, a postcard, or an overhead projector (OHP) sheet; hereinafter, simply described as a sheet) and output the sheet. The printing apparatus 7 can perform full-color printing. As a printing method, various printing methods may be used, such as an electrophotographic method, an inkjet method, a dye-sublimation thermal transfer method, a silver halide photography method, a direct thermal recording method, or a fusion thermal transfer method. In the above embodiments, a printing apparatus of an electrophotographic type is used by way of example.

The image read control unit 12 drives the image reading apparatus 8 under the control of the image processing control unit 10, focuses reflection light, which is caused by light emission from a lamp to the surface of an original, onto a receiving element (for example, a charge coupled device (CCD)) by using a mirror and a lens, and generates 8-bit based RGB digital image data through analog-to-digital conversion.

The image processing control unit 10 described above is structured as a microcomputer system including a central processing unit (CPU) 13 as a main processor, a memory device 14 (for example, a synchronous dynamic random access memory (SDRAM)) for temporarily storing data used in each process, a read only memory (ROM) 15 for storing a control program or the like, and a non-volatile random access memory (NVRAM) 16 that stores a system log, a system setting, or log information and that can store data even when the power is off, which are connected to one another via a bus.

To the image processing control unit 10, a HDD 30 is connected that accumulates a large volume of image data, that accumulates job histories, and that stores image data related to conversion from image data based on R (red), G (green), and B (blue) read from the image reading apparatus 8 into digital image data based on C (cyan), M (magenta), Y (yellow), and K (black) to be provided to the printing apparatus. The image processing control unit 10 is connected to a LAN control unit 18 for connecting the image processing apparatus 300, 320, or 350 to a LAN via a HUB 19 that is a line concentrator provided inside the apparatus. The image processing control unit 10 is also connected to a FAX control unit 20 that controls a facsimile (FAX). The FAX control unit 20 is connected to a private branch exchange (PBX) 22 communicating with a public telephone line so as to enable communication with the image processing apparatus 300, 320, or 350, and a remote facsimile machine.

To the image processing control unit 10, a display control unit 23 and an operation input control unit 24 are connected. The display control unit 23 controls display of images on an operation panel P according to a control signal from the image processing control unit 10.

The operation input control unit 24 inputs an input control signal corresponding to a function setting or an input operation performed by an operator via the operation panel P according to a control signal from the image processing control unit 10. The operation panel includes a display device 40, such as a liquid crystal display (LCD), and an operation input device 41.

The operation input device 41 includes a touch panel of an ultrasonic elastic wave type deposited on the surface of the display device 40 and includes a keyboard formed of a plurality of keys. In the keyboard, for example, a start key for starting read of an image, numeric keys for inputting values, a read condition setting key for setting a transmission destination of the read image data, and a clear key are provided. Specifically, the display control unit 23 outputs an image display control signal to the display device 40 through a control panel I/F 25 and displays predetermined items corresponding to the image display control signal on the display device 40.

Meanwhile, the operation input control unit 24 receives an input control signal corresponding to a functional setting or an input operation performed by an operator using the operation input device 41, through the control panel I/F 25. The HDD 30 stores therein various types of information.

In the above embodiments, an example has been explained in which the image processing apparatus is applied to a multifunction peripheral having at least two of a copy function, a printer function, a scanner function, and a facsimile function. However, the present invention can be applied to any image forming apparatus, such as a copier, a printer, a scanner, or a facsimile apparatus.

Furthermore, each of the information processing apparatuses and the power supply apparatuses according to the first to the fifth embodiments includes a control device, such as a CPU; a storage device, such as a ROM or a RAM; an external storage device, such as a HDD or a compact disc (CD) drive; a display device, such as a display; and an input device, such as a keyboard or a mouse. Each of the information processing apparatuses and the power supply apparatuses has a hardware configuration using a normal computer.

Each of the programs executed by the information processing apparatuses, the power supply apparatuses, and the image processing apparatuses according to the embodiments is provided by being recorded in a computer-readable recording medium, such as a CD-ROM, a flexible disk (FD), a compact disc recordable (CD-R), or a digital versatile disk (DVD), in a computer-installable or a computer-executable file format.

Each of the programs executed by the information processing apparatuses, the power supply apparatuses, and the image processing apparatuses according to the embodiments may be stored in a computer connected to a network, such as the Internet, and may be provided by being downloaded via the network. Each of the programs executed by the information processing apparatuses, the power supply apparatuses, and the image processing apparatuses according to the embodiments may be provided or distributed via a network, such as the Internet. Each of the programs executed by the information processing apparatuses, the power supply apparatuses, and the image processing apparatuses according to the embodiments may be provided by being pre-installed in a ROM or the like.

The program executed by the information processing apparatuses of the embodiments has a module structure including the above units (the communication unit, the communication monitoring unit, the receiving unit, the execution instruction processing unit, and the power processing unit). As actual hardware, the CPU (processor) reads the program from the recording medium and executes the program to load the units on a main storage device, thereby generating the communication unit, the communication monitoring unit, the receiving unit, the execution instruction processing unit, and the power processing unit on the main storage device. The same applies to the programs executed by the power supply apparatuses and the image processing apparatuses, and each of the programs has a module structure including corresponding units among the above-described units.

According to the embodiments, when a power supply apparatus receives an execution instruction from an information processing apparatus, the power supply apparatus starts power supply to an image processing apparatus. Therefore, the image processing apparatus can receive the execution instruction after the power supply thereto is started and can perform a process according to the execution instruction. In this way, it is possible to turn on the image processing apparatus at an appropriate timing without a user operation for turning on the image processing apparatus. In particular, it is possible to turn on the power of the image processing apparatus at an appropriate timing when the image processing apparatus is in a standby state in which the power is off.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing system comprising:
a first image processing apparatus;
an information processing apparatus configured to transmit an instruction on image processing to the first image processing apparatus, the information processing apparatus being connected to the first image processing apparatus via a network; and
a power supply apparatus configured to supply power to the first image processing apparatus, the power supply apparatus being connected to the information processing apparatus via the network, wherein
the information processing apparatus includes
an execution instruction receiving unit configured to receive an execution instruction on a predetermined process to be performed by the first image processing apparatus;
a first transmitting unit configured to transmit, to the power supply apparatus, a first start instruction to start power supply to the first image processing apparatus when the execution instruction is received;
a first communication monitoring unit configured to monitor whether a communication with the first image processing apparatus is enabled; and
a second transmitting unit configured to transmit, to the first image processing apparatus, the execution instruction and execution information needed to perform the predetermined process when the communication with the first image processing apparatus is enabled,
the power supply apparatus includes
a first receiving unit configured to receive the first start instruction from the information processing apparatus; and
a power control unit configured to start power supply to the first image processing apparatus when the first start instruction is received, and
the first image processing apparatus includes
a first power supply unit configured to start power supply to components of the first image processing apparatus when power is supplied by the power supply apparatus;
a second receiving unit configured to receive the execution instruction and the execution information from the information processing apparatus when the first power supply unit starts power supply to the components of the first image processing apparatus; and
a first processing unit configured to perform the predetermined process according to the execution instruction based on the execution information.

2. The image processing system according to claim 1, wherein
when the communication with the first image processing apparatus is not enabled after a lapse of a predetermined time since the first transmitting unit transmits the first start instruction, the first transmitting unit of the information processing apparatus transmits, to the power supply apparatus, a restart instruction to stop power supply to the first image processing apparatus and then restart power supply to the first image processing apparatus, and
the first receiving unit of the power supply apparatus further receives the restart instruction, and
when the first receiving unit receives the restart instruction, the power control unit of the power supply apparatus stops power supply to the first image processing apparatus and then restarts power supply to the first image processing apparatus.

3. The image processing system according to claim 1, further comprising a second image processing apparatus configured to receive power from the first power supply apparatus, the second image processing apparatus being connected to the information processing apparatus via the network, wherein
the second image processing apparatus includes
a second power supply unit configured to start power supply to components of the second image processing apparatus when power is supplied by the power supply apparatus;
a third receiving unit configured to receive the execution instruction and the execution information from the information processing apparatus when the second power supply unit starts power supply to the components of the second image processing apparatus; and
a second processing unit configured to perform the predetermined process according to the execution instruction based on the execution information,
when the communication with the first image processing apparatus is not enabled after a lapse of a predetermined time since the first transmitting unit transmits the first start instruction, the first transmitting unit of the information processing apparatus transmits, to the power supply apparatus, a second start instruction to start power supply to the second image processing apparatus,
the first communication monitoring unit of the information processing apparatus monitors whether a communication with the second image processing apparatus is enabled,
the information processing apparatus further includes a third transmitting unit configured to transmit the execution instruction and the execution information to the second image processing apparatus when the communication with the second image processing apparatus is enabled,
the first receiving unit of the power supply apparatus further receives the second start instruction from the information processing apparatus, and
the power control unit of the power supply apparatus starts power supply to the second image processing apparatus when the second instruction is received.

4. The image processing system according to claim 1, wherein
the first image processing apparatus further includes
a power-off instruction receiving unit configured to receive a power-off instruction to stop power supply to the components of the first image processing apparatus; and
a fourth transmitting unit configured to transmit the power-off instruction to the information processing apparatus when the power-off instruction is received,
the information processing apparatus further includes a fourth receiving unit configured to receive the power-off instruction,
the first transmitting unit of the information processing apparatus transmits, to the power supply apparatus, a stop instruction to stop power supply to the first image processing apparatus when the power-off instruction is received, and
the power control unit of the power supply apparatus stops power supply to the first image processing apparatus when the first receiving unit receives the stop instruction.

5. The image processing system according to claim 1, wherein
the information processing apparatus further includes a power-off instruction receiving unit configured to receive a power-off instruction to stop power supply to the components of the first image processing apparatus,
the first transmitting unit of the information processing apparatus transmits, to the power supply apparatus, a stop instruction to stop power supply to the first image processing apparatus when the power-off instruction is received, and
the power control unit of the power supply apparatus stops power supply to the first image processing apparatus when the first receiving unit receives the stop instruction.

6. The image processing system according to claim 1, wherein
the first image processing apparatus further includes
a power-off instruction receiving unit configured to receive a power-off instruction to stop power supply to the components of the first image processing apparatus; and
a fifth transmitting unit configured to transmit, to the power supply apparatus, a stop instruction to stop power supply to the first image processing apparatus when the power-off instruction is received,
the power supply apparatus further includes a fifth receiving unit configured to receive the stop instruction from the first image processing apparatus, and
the power control unit of the power supply apparatus stops power supply to the first image processing apparatus when the stop instruction is received.

7. The image processing system according to claim 1, wherein
the power supply apparatus is connected to the first image processing apparatus via the network and via a power line that enables power supply,
the power supply apparatus and the first image processing apparatus transmit and receive information to and from each other via the network, and
the power supply apparatus supplies power to the first image processing apparatus via the power line.

8. The image processing system according to claim 1, wherein
the power supply apparatus is connected to the first image processing apparatus via a power communication line that enables both information transmission and power supply,
the power supply apparatus and the first image processing apparatus transmit and receive information to and from each other via the power communication line, and
the power supply apparatus supplies power to the first image processing apparatus via the power communication line.

9. The image processing system according to claim 8, wherein
the first image processing apparatus further includes a sixth transmitting unit configured to transmit identification information for identifying the first image processing apparatus to the power supply apparatus via the power communication line when the first image processing apparatus recieves power from the power supply apparatus via the power communication line,
the power supply apparatus further includes
a sixth receiving unit configured to receive the identification information from the first image processing apparatus via the power communication line; and
a seventh transmitting unit configured to transmit the identification information to the information processing apparatus via the network when the identification information is received, and
the information processing apparatus further includes
a storage unit; and
a seventh receiving unit configured to receive the identification information from the power supply apparatus and store the received identification information in the storage unit.

10. The image processing system according to claim 8, wherein
the sixth transmitting unit of the first image processing apparatus transmits a power-on instruction to the power supply apparatus via the power communication line when a power-on event for turning on power occurs in the first image processing apparatus,
the sixth receiving unit of the power supply apparatus receives the power-on instruction from the first image processing apparatus via the power communication line, and
the power control unit of the power supply apparatus starts power supply to the first image processing apparatus via the power communication line when the power-on instruction is received.

11. An image processing system comprising:
an image processing apparatus;
an information processing apparatus configured to transmit an instruction on image processing to the image processing apparatus, the information processing apparatus being connected to the image processing apparatus via a network; and
a power supply apparatus configured to supply power to the image processing apparatus, the power supply apparatus being connected to the image processing apparatus and the information processing apparatus via the network, wherein
the information processing apparatus includes
an execution instruction receiving unit configured to receive an execution instruction on a predetermined process to be performed by the image processing apparatus; and
a first transmitting unit configured to transmit, to the power supply apparatus, a start instruction to start power supply to the image processing apparatus, the execution instruction, and execution information needed to perform the predetermined process when the execution instruction is received,
the power supply apparatus includes
a first receiving unit configured to receive the start instruction, the execution instruction, and the execution information from the information processing apparatus;
a power control unit configured to start power supply to the image processing apparatus when the start instruction is received;
a communication monitoring unit configured to monitor whether a communication with the image processing apparatus is enabled; and
a second transmitting unit configured to transmit the execution instruction and the execution information to the image processing apparatus when the communication with the image processing apparatus is enabled, and
the image processing apparatus includes
a power control unit configured to start power supply to components of the image processing apparatus when power is supplied by the power supply apparatus;
a second receiving unit configured to receive the execution instruction and the execution information from the power supply apparatus when the power supply unit starts power supply to the components unit of the image processing apparatus; and
a processing unit configured to perform the predetermined process according to the execution instruction based on the execution information.

12. The image processing system according to claim 11, wherein
the power supply apparatus is connected to the image processing apparatus via the network and a power line that enables power supply,
the power supply apparatus and the image processing apparatus transmit and receive information to and from each other via the network, and
the power supply apparatus supplies power to the image processing apparatus via the power line.

13. The image processing system according to claim 11, wherein
the power supply apparatus is connected to the image processing apparatus via a power communication line that enables both information transmission and power supply,
the power supply apparatus and the image processing apparatus transmit and receive information to and from each other via the power communication line, and
the power supply apparatus supplies power to the image processing apparatus via the power communication line.

14. The image processing system according to claim 13, wherein
the image processing apparatus further includes a sixth transmitting unit configured to transmit identification information for identifying the image processing apparatus to the power supply apparatus via the power communication line when the power supply apparatus supplies power via the power communication line,
the power supply apparatus further includes
a sixth receiving unit configured to receive the identification information from the image processing apparatus via the power communication line; and
a seventh transmitting unit configured to transmit the received identification information to the information processing apparatus via the network when the identification information is received, and
the information processing apparatus further includes
a storage unit; and
a seventh receiving unit configured to receive the identification information from the power supply apparatus and store the received identification information in the storage unit.

15. The image processing system according to claim 13, wherein
the sixth transmitting unit of the image processing apparatus transmits a power-on instruction to the power supply apparatus via the power communication line when a power-on event for turning on the image processing apparatus occurs in the image processing apparatus,
the sixth receiving unit of the power supply apparatus receives the power-on instruction from the image processing apparatus via the power communication line, and
the power control unit of the power supply apparatus starts power supply to the image processing apparatus via the power communication line when the power-on instruction is received.

16. An image processing method for an image processing system that includes an image processing apparatus, an information processing apparatus that is connected to the first image processing apparatus via a network and that transmits an instruction on image processing to the image processing apparatus, and a power supply apparatus that is connected to the information processing apparatus via the network and that supplies power to the image processing apparatus, the image processing method comprising:
receiving, by the information processing apparatus, an execution instruction on a predetermined process to be performed by the image processing apparatus;
transmitting, from the information processing apparatus to the power supply apparatus, a start instruction to start power supply to the image processing apparatus when the execution instruction is received;
monitoring, by the information processing apparatus, whether a communication with the image processing apparatus is enabled;
transmitting, from the information processing apparatus to the image processing apparatus, the execution instruction and execution information needed to perform the predetermined process when the communication with the image processing apparatus is enabled;
receiving, by the power supply apparatus, the start instruction from the information processing apparatus;
starting, by the power supply apparatus, power supply to the image processing apparatus when the start instruction is received;
starting, by the image processing apparatus, power supply to components of the image processing apparatus when power is supplied by the power supply apparatus;
receiving, by the image processing apparatus, the execution instruction and the execution information from the information processing apparatus when power supply to the components of the image processing apparatus is started; and
executing, by the image processing apparatus, the predetermined process according to the execution instruction based on the execution information.
